(19) United States
(12) Patent Application Publication
(10) Pub. No.: US 2018/0297116 A1
(43) Pub. Date: Oct. 18, 2018

(54) DEVICE AND METHOD FOR ADDITIVE MANUFACTURING

(71) Applicant: SIEMENS AKTIENGESELLSCHAFT, München (DE)

(72) Inventors: Christian Brunhuber, Auerbach (DE); Thomas Soller, Deggendorf (DE)

(73) Assignee: Siemens Aktiengesellschaft, Munich (DE)

(21) Appl. No.: 15/762,710

(22) PCT Filed: Sep. 9, 2016
(86) PCT No.: PCT/EP2016/071290

§ 371 Date: Mar. 23, 2018

(30) Foreign Application Priority Data
Oct. 7, 2015 (DE) 10 2015 219 355.1

(51) Int. Cl. B22F 3/105; B22F 1/00

(52) U.S. Cl. CPC B22F 3/1055; B33Y 10/00; B22F 1/0085

(57) ABSTRACT

A device and a method additive manufacturing, the device has a movable platform, on which a powder bed is gradually built up using successively added powder for powder layers, and on which a component is produced step by step; a process chamber, wherein the powder bed is compressed selectively by means of an energy beam; a powder reservoir from which powder is applied layer by layer for a new powder layer of the powder bed; and a preheating chamber, wherein the preheating chamber selectively preheats the powder that is to be applied for a new powder layer from the powder reservoir, and into which the quantity of powder required for applying a new powder layer is metered.

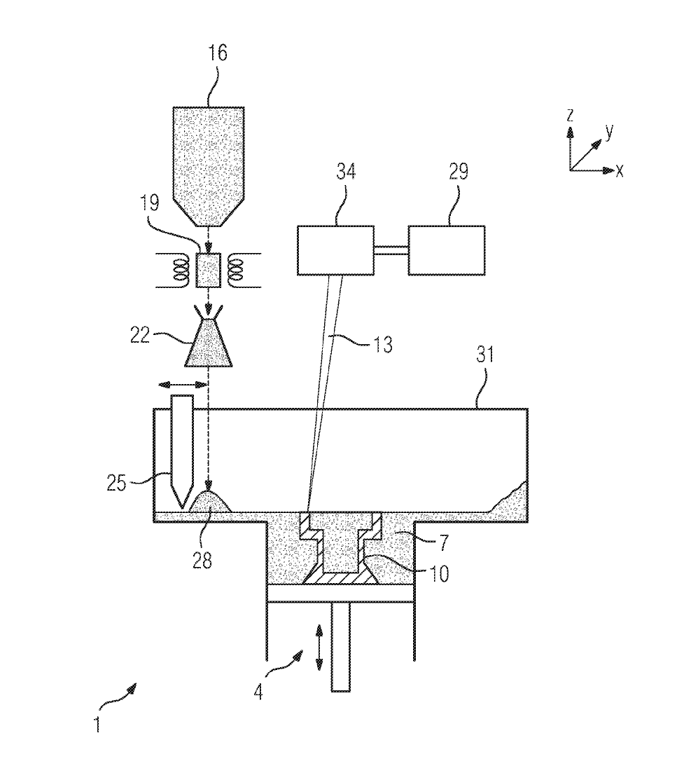

### CROSS REFERENCE TO RELATED APPLICATIONS

This application is the US National Stage of International Application No. PCT/EP2016/071290 filed Sep. 9, 2016, and claims the benefit thereof. The International Application claims the benefit of German Application No. DE 102015219355.1 filed Oct. 7, 2015. All of the applications are incorporated by reference herein in their entirety.

### FIELD OF INVENTION

The invention relates to an apparatus for additive manufacturing, and to a corresponding manufacturing method.

### BACKGROUND OF INVENTION

Generative or additive manufacturing methods represent a novel approach to the production of components having high geometric complexity. They are characterized by the fact that manufacturing is on the basis of virtual data models, using shapeless or shape-neutral materials such as powders or liquids by means of chemical and/or physical processes.

Of particular importance in the context of turbine engineering and turbine servicing are beam melting methods such as selective laser melting (SLM), laser metal deposition (LMD) or electron beam melting (EBM), since these are the methods that can be used to process metallic materials.

Since the energy input from the melting beam is very localized, and heat dissipation by the powdery starting material is very poor, the materials experience steep thermal gradients which promote hot crack formation. In particular, the high-temperature alloys used for rotor blades, stator vanes and combustor components typically have poor weldability and a strong tendency to hot cracking during processing using laser-based methods, and as a result the components thus obtained have a high defect rate.

Also when processing dissimilar materials, in particular metal and ceramic, the steep temperature gradients represent a problem, and this hinders in-situ bonding of these material classes with one another by means of generative methods.

Owing to the poor weldability of the eligible materials, those components that are subject to high loads are currently produced exclusively by investment casting.

EP 2 859 973 A1 describes an arrangement for processing powder and a method for use in a device for producing three-dimensional components.

DE 10 2014 204 580 A1 describes a device and a method for the layer-by-layer generation of components, and a corresponding process chamber.

U.S. 2013/0186514 A1 further describes a system and a method for spreading or applying powder, and an additive manufacturing method that uses the system.

In most concepts currently under testing, the generative process in the powder bed process such as SLM/EBM is carried out at high temperatures, thus making it possible to avoid rapid cooling and the associated hot cracking. In the case of nickel-based alloys having a high γ′ fraction, preheating temperatures of for example 1273K are advantageous, while lower preheating temperatures of 1073K already lead to markedly higher crack formation. To heat the process chamber, use is made of resistive heating, inductive heating or heating by means of IR radiators.

In the case of heating by irradiation, heating is carried out only after application of the layer that is to be processed, which is technically difficult to bring about. Rapid heating by means of movable coils in the construction space, in which context the coils must not enter the laser beam, also appears to be technically demanding.

The case of a heated base plate is indeed very simple to realize but, with increasing construction height, significant deviations can occur, across the various layers of molten material and powder, between the actual temperature in the uppermost powder layer and the desired preheating temperature.

### SUMMARY OF INVENTION

The invention has an object of solving the aforementioned problem.

The object is achieved with a device and with a method as claimed.

The dependent claims list further advantageous measures which can be combined with one another, as desired, in order to obtain further advantages.

The figure and the description represent only exemplary embodiments of the invention.

In the invention—in a deviation from the prior art—the primary heating of the powder is to take place not just in the process chamber of the SLM or EBM installation, but already prior to scraping of the powder, that is to say prior to the powder being spread out evenly as a fine layer in the process chamber. The preheated powder is then spread out in the process chamber while hot, advantageously by means of a solid ceramic or ceramic-coated wiper, and is then directly processed by beam melting.

The powder is to be heated such that, from a powder supply container, the quantity of powder required for applying a new powder layer is metered into a small heating chamber. The powder aliquot is then heated to the required process temperature, advantageously using inductive heating. The heated powder is then placed evenly along the ceramic scraper blade or ceramic drawing frame by means of a suitable mechanism, advantageously in this case by means of a splash-plate arrangement. The wiping of the hot powder and the generative processing then proceed as usual.

In the case of applications with very high preheating temperatures, such as nickel-based alloys with a high γ′ fraction, there is a risk of rapid cooling of the first powder layer owing to the large temperature difference with respect to the rest of the powder bed. A correspondingly more intense preheating is not possible in this case since the metal particles risk sintering in the heating chamber.

In this case, it is however possible, in a particularly advantageous embodiment of the invention, to combine the application of the preheated powder with resistive heating of the base or of the powder bed. The resistive base heating raises the temperature in the entire powder bed, which prevents rapid cooling of the preheated first powder layer. By choosing a suitable target temperature for the base heating, it is in particular possible to achieve that, during scraping and laser melting of the preheated powder, the preheating temperature does not enter a temperature range that would be prejudicial to the process, in particular 973K-1173K for nickel-based alloys having a high γ′ fraction.

Example: In the case of a construction chamber surface area of 0.5 m×0.5 m, and a layer thickness of 20 μm, a powder volume of the order of 5 cm³ would have to be heated in order to be able to apply a new powder layer. If the bulk density of the powder is assumed to be 5 g/cm³, this corresponds to 25 g of powder.

The inventive step lies in the integration of a preheating of the metallic powder raw material prior to distribution of the powder into the construction chamber, and suitable adaptation of the powder preparation and application system in the SLM process, with or without resistive powder bed heating.

This results in, inter alia, the following advantages:—shorter processing times in comparison to full construction chamber heating (owing to shorter cooling times after the end of the generative production),—cost savings resulting from a simplified preheating device (in particular in comparison to radiation heating),—better component quality as a result of more precise control of the preheating temperature,—the possibility of processing compounds that, to date, could not be generatively processed (i.e. in particular those which have poor weldability),—applicability to a wide variety of materials; suitable for reproducible mass production.

### BRIEF DESCRIPTION OF THE DRAWINGS

The FIGURE shows a device 1 according to the invention.

### DETAILED DESCRIPTION OF INVENTION

The FIGURE and the description represent only exemplary embodiments of the invention.

As in the prior art, the device 1 has a movable platform 4 on which a powder bed 7 is built up. The platform 4 can be moved down in one direction (the Z direction) in order to be able to apply a new layer of powder. A component 10 that is to be produced is present or generated in the powder bed 7.

In the process chamber 31, an energy beam 13, in particular a laser beam 13 of a laser 29, and a corresponding scanner 34 are used to selectively compress, i.e. sinter or melt, the powder layer by layer to form the component 10.

As in the prior art, a wiper 25 is used to apply powder 28 as a new layer once the platform 4 has been lowered by a certain value.

According to the invention, however, this newly applied powder 28 is preheated.

This can be done in various ways.

Another heating device can be present, which preheats the entire powder reservoir 16, as per the prior art.

It is also possible, as shown in the drawing, for powder from a powder reservoir 16 to be selectively preheated in a preheating chamber 19, as a powder quantity that is to be applied for one powder layer, and optionally introduced into the process chamber 31 by means of a corresponding distributor 22 so that, there, it can be introduced into the process chamber 31 as a powder layer by means of the wiper 25.

The distributor 22 and the preheating chamber 19 can also be designed together as a subassembly.

Optionally, the process chamber can also heat the existing powder bed 7 in various ways, inductive heating being particularly suitable in the case of metal powders.

1-5. (canceled)

6. A device for additive manufacturing, comprising:
a movable platform, on which a powder bed is gradually built up using successively added powder for powder layers, and on which a component is produced step by step;
a process chamber, wherein the powder bed is compressed selectively by means of an energy beam;
a powder reservoir from which powder is applied layer by layer for a new powder layer of the powder bed; and
a preheating chamber, wherein the preheating chamber selectively preheats the powder that is to be applied for a new powder layer from the powder reservoir, and into which the quantity of powder required for applying a new powder layer is metered.

7. The device as claimed in claim 6, further comprising:
another heating device to heat the existing powder bed.

8. A method for the additive manufacturing of a component, using a device as claimed in claim 6, the method comprising:
preheating the powder for the powder layer; and
selectively compressing the powder bed by means of an energy beam.

9. The method as claimed in claim 8, further comprising:
heating the existing powder bed.

10. The device as claimed in claim 6,
wherein the powder bed is compressed selectively by means of a laser beam.

11. The device as claimed in claim 6, further comprising:
a spreader adapted to introduce the powder into the process chamber, so that the heated powder is spread, as a powder layer, over the existing powder bed.
